(19) United States
(12) Patent Application Publication
(10) Pub. No.: US 2002/0185209 A1
(43) Pub. Date: Dec. 12, 2002

(54) Method and apparatus for improving the rolling efficiency of a wheel

(76) Inventor: Martin Nick Leibowitz, Hillsboro Beach, FL (US)

Correspondence Address: Jeffery L. Snow, Kirkpatrick & Lockhart LLP, 75 State Street, Boston, MA, 02109, US

(21) Appl. No.: 10/164,851

(22) Filed: Jun. 7, 2002

Related U.S. Application Data
(60) Provisional application No. 60/296,720, filed on Jun. 8, 2001.
(60) Provisional application No. 60/307,114, filed on Jul. 23, 2001.

(51) Int. Cl. B29D 30/00

(52) U.S. Cl. 156/123; 156/110.1; 152/548

(57) ABSTRACT

A method and apparatus for improving the rolling efficiency of a wheel includes a circular frame capable of rolling along a rolling surface, a rolling assembly for causing the circular frame to rotate, and a shock absorbing means connecting the rolling assembly and the circular frame wherein the circular frame maintains a substantially rounded area of contact with the rolling surface.

### CROSS REFERENCE TO RELATED APPLICATIONS

This application claims priority to U.S. Provisional Application S. No. 60/296,720, filed Jun. 8, 2001, entitled ‘INTIRE’ WHEEL APPARATUS & METHODS and U.S. Provisional Application S. No. 60/307,114, filed Jul. 23, 2001, entitled OFF-BALANCED FORCE APPARATUS & METHODS, the disclosures of which are incorporated by reference herein.

### BACKGROUND OF THE INVENTION

1. Field of the Invention

The present invention relates in general to the field of wheels, and in particular to mechanisms and methods for improving the efficiency of the rolling of a wheel.

2. Background

Wheels are used in a variety of commercial, industrial, and recreational settings. Traditional pneumatic wheels, e.g., tires have a flat area on the bottom of the wheel which contacts a rolling surface, e.g., a road. Typically, a load applied to the wheel increases the area that contacts the rolling surface. As the contact area of the wheel increases, a greater initial force is required to begin moving or rolling the wheel, and a greater force is required to keep the wheel rolling once it has begun to move. In addition, with increased contact area, the wheel experiences greater wear and friction.

### SUMMARY OF THE INVENTION

In general, in one aspect, the invention features a wheel apparatus for rolling along a rolling surface. Wheel apparatus includes a circular frame capable of rolling along the rolling surface, a rolling assembly for causing the circular frame to rotate, and a shock absorbing means connecting the rolling assembly and the circular frame wherein the circular frame maintains a substantially rounded area of contact with the rolling surface.

In general, in another aspect, the invention features a wheel apparatus for rolling along a rolling surface. Wheel apparatus includes a tire having an inner surface and an outer surface, the outer surface of the tire being capable of rolling along the rolling surface and a frame inserted in the tire and disposed in contact with the inner surface of the tire wherein the tire maintains a substantially rounded area of contact with the rolling surface.

In general, in one another aspect, the invention features a method of improving the rolling efficiency of a wheel apparatus along a rolling surface. A circular frame capable of rolling along the rolling surface is provided and a substantially rounded area of contact of the circular frame with the rolling surface is maintained.

### DESCRIPTION OF THE FIGURES

FIG. 1A is a schematic cross-sectional view of an automobile tire of the prior art shown with and without an applied load;

FIG. 1B is a schematic side view and cross-sectional view of an automobile tire of the prior art shown with an applied load;

FIG. 2 is a schematic side view of a wheel apparatus according to an embodiment of the present invention;

FIG. 3 is a schematic cross-sectional view of a wheel apparatus along line A-A of FIG. 2 according to an embodiment of the present invention;

FIG. 4A is a schematic cross-sectional view of a wheel apparatus according to an embodiment of the present invention shown with and without an applied load;

FIG. 4B is a schematic side view and cross-sectional view of a wheel apparatus according to an embodiment of the present invention shown with an applied load;

FIG. 5 is a schematic side view of a wheel apparatus with flexible bands according to an embodiment of the present invention;

FIG. 6 is a schematic side view of a wheel apparatus with a hub and regulator mechanism according to an embodiment of the present invention;

FIG. 7 is an exploded top view of the hub and regulator mechanism shown in FIG. 6;

FIG. 8 is an exploded plan view of the hub and regulator mechanism shown in FIG. 6;

FIG. 9 is a plan view along plane B of FIG. 8;

FIG. 10 is a schematic side view of a bicycle showing an embodiment of the wheel apparatus according to the present invention;

FIG. 11 is a schematic cross-sectional view of a modified automobile tire with a frame inserted therein according to an embodiment of the present invention shown with and without an applied load;

FIG. 12 is a schematic plan view of a modified automobile tire with a frame inserted therein according to an embodiment of the present invention;

FIG. 13 is a schematic exploded cross-sectional view the modified automobile tire shown in FIG. 12;

FIG. 14A is a schematic side view of an assembled frame according to an embodiment of the present invention;

FIG. 14B is a schematic plan view of an assembled frame according to an embodiment of the present invention;

FIG. 14C is a schematic side view of a frame section according to an embodiment of the present invention;

FIG. 14D is a schematic top view of a frame section according to an embodiment of the present invention;

FIG. 15A is an exploded plan view of an end of the frame section shown in FIGS. 14C and 14D;

FIG. 15B is an exploded side view of the assembled frame shown in FIGS. 14A and 14B; and

FIG. 15C is an exploded cross-sectional view of the assembled frame shown in FIG. 15B.

### DETAILED DESCRIPTION OF THE INVENTION

The present invention relates to a wheel having a substantially rounded area of contact with the rolling surface. The wheel apparatus maintains a smooth, continuous, round rolling fulcrum, even when a load is applied to the wheel, to improve the rolling efficiency of the wheel. Thus, as the wheel begins to roll, the bottom of the wheel in contact with the rolling surface remains substantially rounded. In one embodiment, the wheel includes a shock absorber disposed around the axis of rotation of the wheel apparatus. For example, the wheel apparatus may include a solid rim or frame with a shock absorber, such as an inflatable inner tire, flexible strips or bands, or solid soft rubber, disposed within the frame and around a bearing or shaft about which the wheel apparatus rotates. In another embodiment, a traditional wheel including a tire is modified to have a smooth, continuous, round rolling fulcrum by inserting a frame into the tire.

In addition, the invention includes a method and apparatus incorporating the “downhill effect” within the wheel as described above. The operative aspects of the downhill effect are explained in detailed, e.g., in U.S. Pat. No. 5,387,818, entitled “Downhill Effect Apparatus and Methods.” A hub positioned within a circular frame is fixedly connected to a rotating shaft or body. One or more regulators are located a fixed position with respect to the hub such that the regulator(s) acting in conjunction with the hub provide a mechanism about which the wheel apparatus may rotate. The hub and regulator mechanism create tension and have an off-balance effect on the wheel apparatus such that the center of the hub is not the center of the circular frame. Thus, the concentrated force is off-balance to, i.e., not directly above, the pivot point located at the contact area of the wheel with respect to the ground. As a result, there is always a “toppling effect” experienced by the inner frame as the wheel apparatus rolls along the rolling surface.

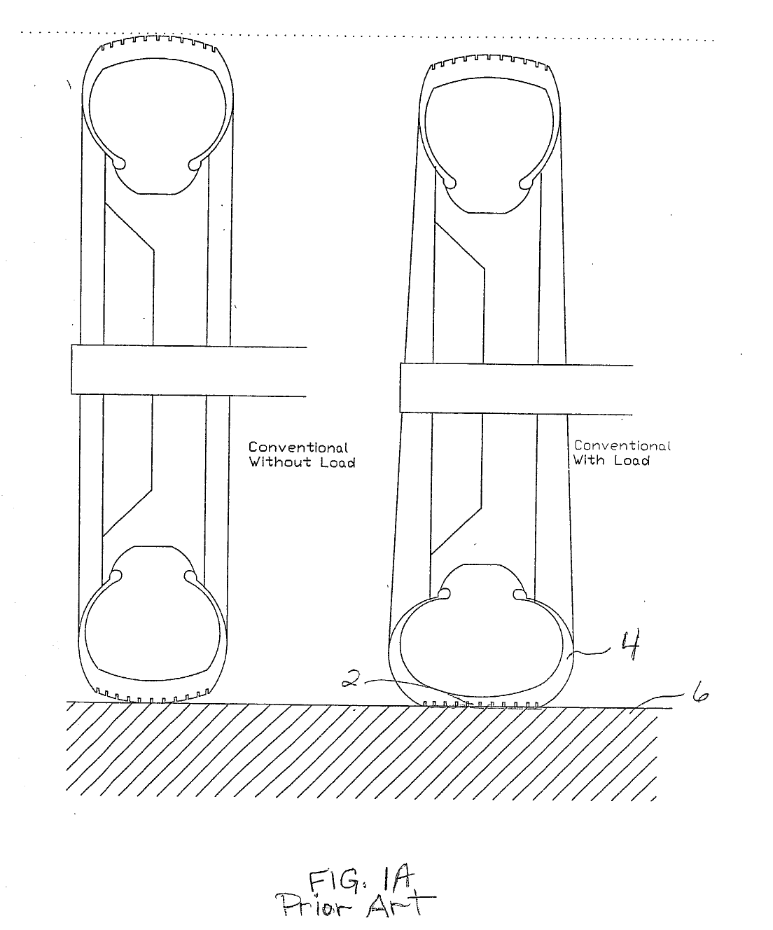

FIG. 1A is a schematic cross-sectional view of an automobile tire of the prior art shown with and without an applied load. FIG. 1B is a schematic side view and cross-sectional view of an automobile tire of the prior art shown with an applied load. The tire 4 has a flat area 2 on its outer surface where the tire contacts the rolling surface 6, e.g., the ground.

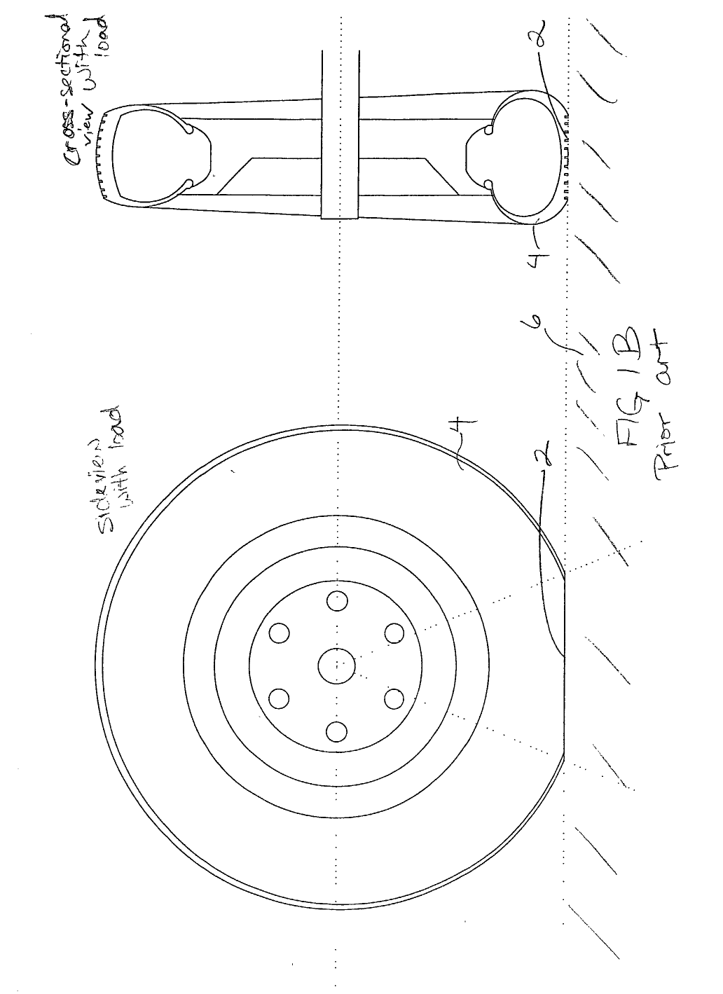

FIG. 2 is a schematic side view of one embodiment of a wheel apparatus 10. Wheel apparatus 10 includes a circular frame 12, an inflatable tube 14, a shaft 16, and a bearing 18. Shaft 16 and bearing 18 may form a rolling assembly that causes circular frame 12 to rotate. Circular frame 12 has an outer surface 12a and an inner surface 12b. Circular frame 12 is preferably made of a hard, durable material, e.g., molded or formed steel, aluminum, or a hard plastic. Circular frame 12 provides the main structural support for the wheel apparatus 10. A hard rubberized layer 20 for rolling may be placed on the outer surface 12a of the circular frame 12 to provide enhanced traction for wheel apparatus 10 with respect to the rolling surface. Inflatable tube 14 has an outer surface 14a and an inner surface 14b. The outer surface 14a of inflatable tube 14 is positioned adjacent to the inner surface 12b of the circular frame 12, and the inner surface 14b of inflatable tube 14 surrounds bearing 18 and/or shaft 16, depending on how the bearing 18 and shaft 16 are arranged, to dampen vibrations to shaft 16 caused by forces resulting from resistance of wheel apparatus 10 moving along the pathway of travel on the rolling surface 6. Thus, any shock applied to wheel apparatus 10 is absorbed in wheel apparatus 10 itself. Further, such shock is not transferred to bearing 18 as much as in traditional wheel designs. Thus, wheel apparatus 10 absorbs forces applied to the wheel within circular frame 12 at a location discrete from the area of contact of circular frame 12 with the rolling surface.

In the embodiment shown in FIG. 2, inflatable tube 14 is capable of being filled with a fluid medium, such as air, through an opening 22 in circular frame 12. The bearing 18 is shown in contact with shaft 16 near the center axis 17 of circular frame 12; however, a variety of different bearing/shaft configurations may be used.

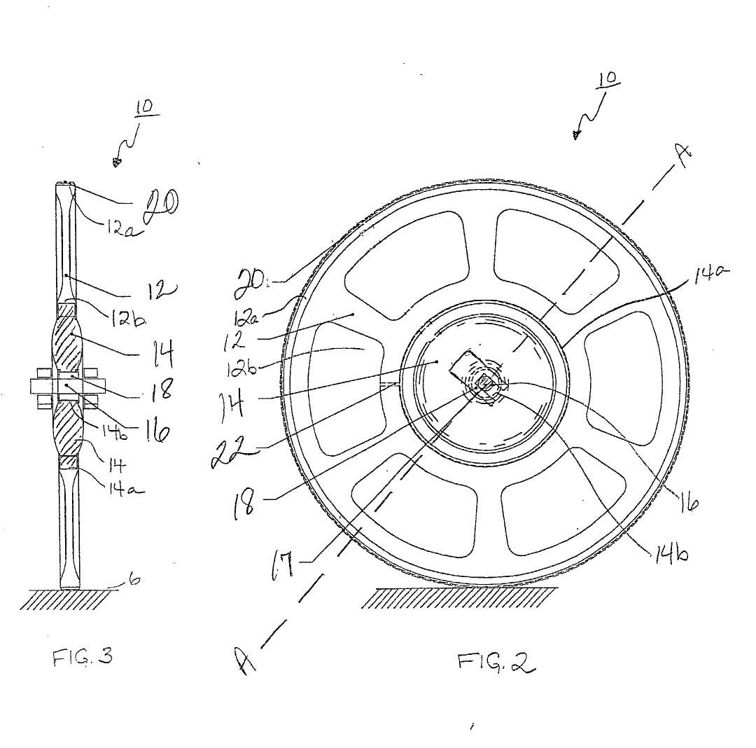

FIG. 3 is a schematic cross-sectional view of wheel apparatus 10 along line A-A of FIG. 1. This view shows how rubberized layer 20 may be secured to the outer surface 12a of circular frame 12, e.g., by bonding, and how the outer surface 14a of inflatable tube 14 fits within the inner surface 12b of circular frame 12. The inflatable tube 14 may be secured in place by various methods, such as bonding or press fitting.

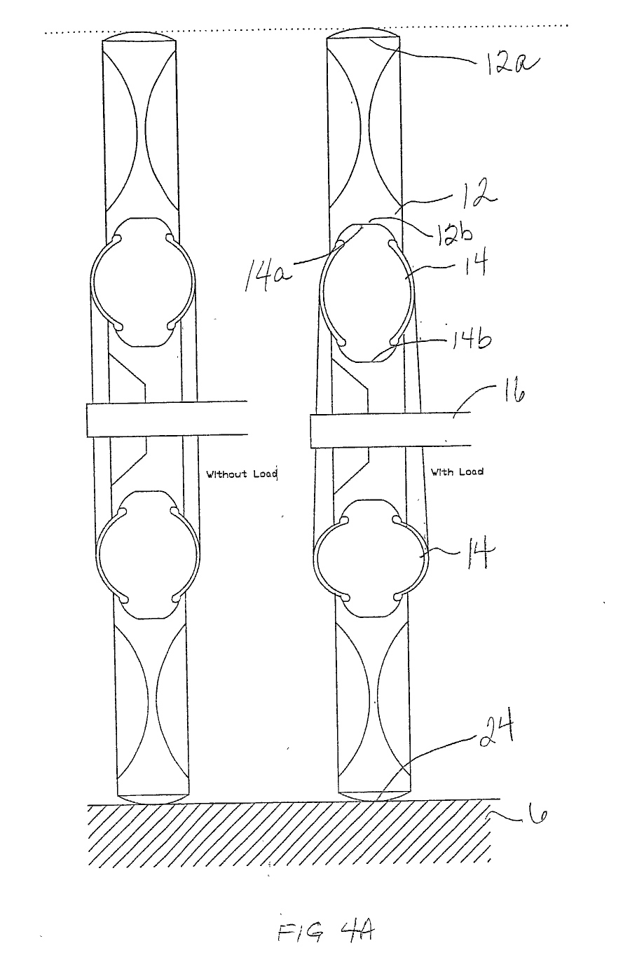

FIG. 4A is a schematic cross-sectional view of wheel apparatus 10 shown with and without an applied load. FIG. 4B is a schematic side view and cross-sectional view of wheel apparatus 10 shown with an applied load. As the wheel begins to turn, there is a small pivot point 24 maintained with respect to the rolling surface 6. Pivot point 24 is a smooth, continuous, round rolling fulcrum for wheel apparatus 10. The present invention allows for greater traction and release at pivot point 24.

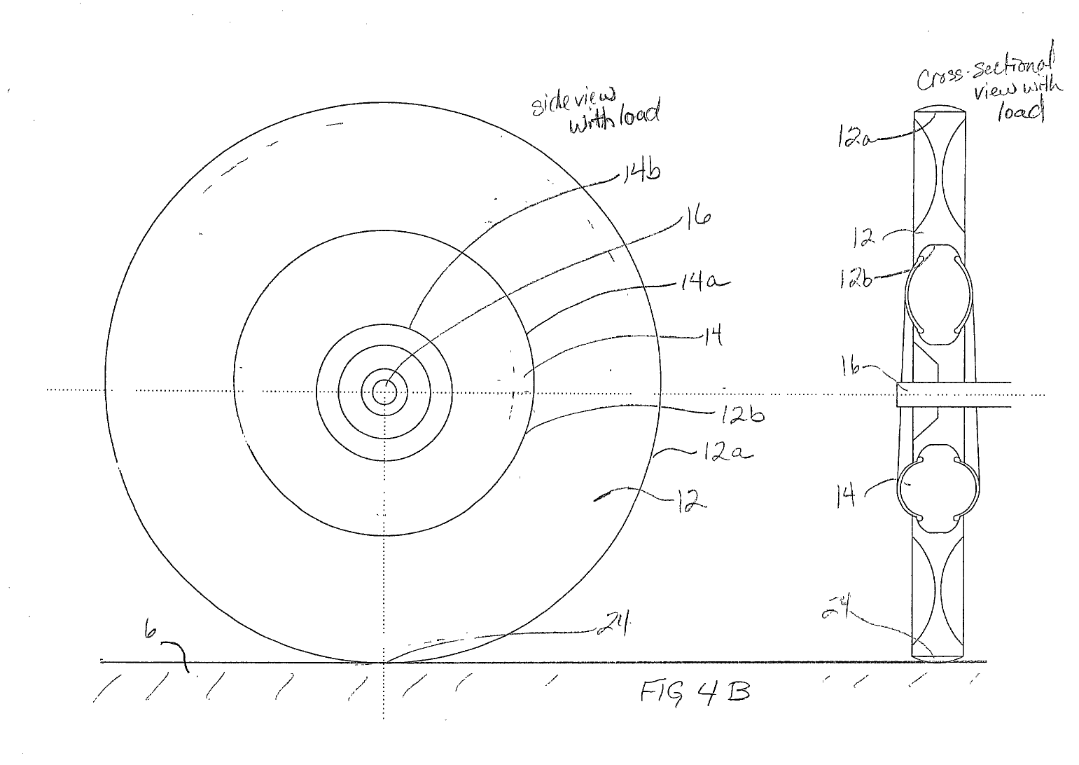

FIG. 5 is a schematic side view of another embodiment of wheel apparatus 10. Wheel apparatus 10 includes a circular frame 12, flexible bands 26, a roller 28, and a roller assembly 15. A hard rubberized layer 20 may be placed around the outer surface 12a of circular frame 12. Roller 28 has an outer surface 28a and an inner surface 28b. Flexible bands 26 are connected at one end to the inner surface 12b of circular frame 12, and at the other end to the outer surface 28a of roller 28. The inner surface 28b of roller 28 houses roller assembly 15. In the embodiment shown in FIG. 5, roller assembly 15 comprises a shaft 16 directly connected to bearings 18. Flexible bands 26 provide wheel apparatus 10 with the shock absorption means similar to the function of inflatable tube 12 as shown in FIGS. 2 and 3. Flexible bands 26 are preferably made of a flexible resilient material, such as spring steel. Although wheel apparatus 10 is presently shown with eight flexible bands 26, it will be apparent to those skilled in the art that any number of flexible bands may be used; however, three or more flexible bands are preferred.

In addition to providing shock absorption, flexible bands 26 contribute to the rolling efficiency of wheel apparatus 10. At various times during the rolling of wheel apparatus 10, shaft 16 may become displaced, creating an off-balance situation with respect to circular frame 12. For example, as wheel apparatus 10 begins to move, shaft 16 may be pushed or pulled forward, depending on the drive mechanism being used to move wheel apparatus 10. In addition, as wheel apparatus 10 is rolling, shaft 16 may experience forces in any direction, depending on the conditions of the rolling surface or the application in which wheel apparatus 10 is being used. As shaft 16 moves slightly away from the center axis 17 of circular frame 12, flexible bands 26 experience compressive or tensile stresses. For example, when shaft 16 is displaced below center axis 17 of circular frame 12, flexible bands below center axis 17 are compressed and flexible bands above center axis 17 are expanded. As flexible bands 26 attempt to return to their pre-stressed position, there is a shock absorbing effect within wheel apparatus 10 as well as a force in the forward direction along the rolling surface.

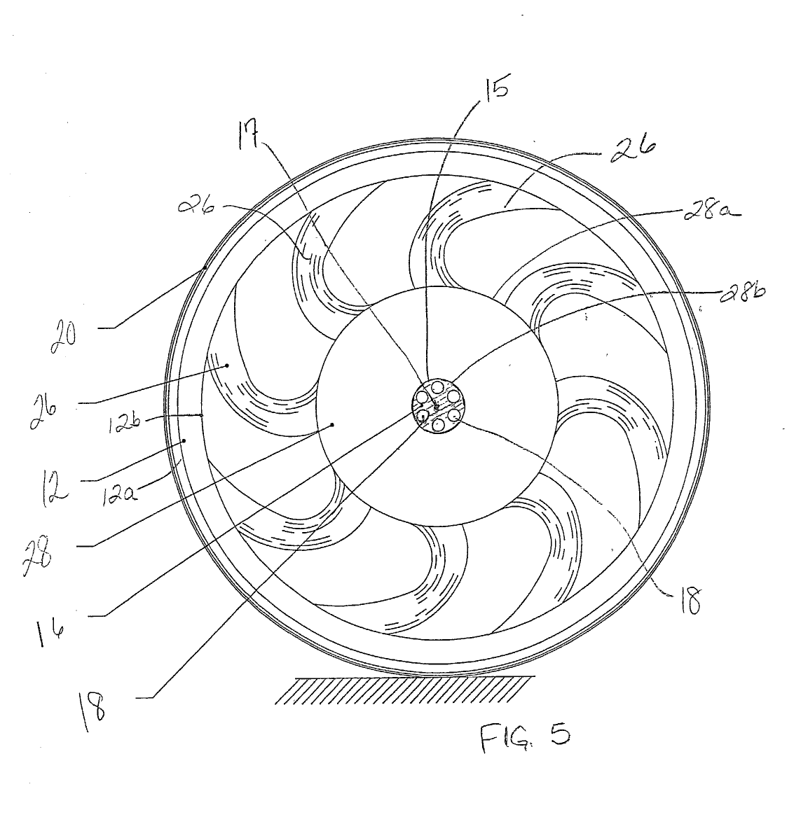

FIG. 6 is a schematic side view of another embodiment of wheel apparatus 10. Wheel apparatus 10 includes a circular frame 12, inflatable tube 14, a roller 28, and a roller assembly 15. Roller assembly 15 comprises a hub and regulator mechanism, and contributes to the rolling efficiency of wheel apparatus 10 by taking advantage of the downhill effect described herein. Essentially, the downhill effect entails rolling masses which rotate about an axis of a fixed member while also rotating about their own center axis. However, the center axis of the mass is eccentric or offset to the center axis of a fixed member, e.g., a ring or roller, which induces the mass to rotate about its center axis and thereby creates a downhill effect and off-balance situation. By the nature of the downhill effect, the entire mass is offset or off-balance and has the effect of falling or rolling towards the rolling surface without actually falling out of position. Moreover, as the torque of the hub is in the same direction as that of rolling, the force is actually pushing the roller and hub in the direction of the motion as well as the natural tendency of the downhill effect. The regenerative gap, which is always in front of the fulcrum point, provides the space for the roller, which is connected to and within the circular frame, to roll freely with little to no resistance, thus allowing wheel apparatus 10 to perpetuate an increase in momentum and/or acceleration with minimal effort.

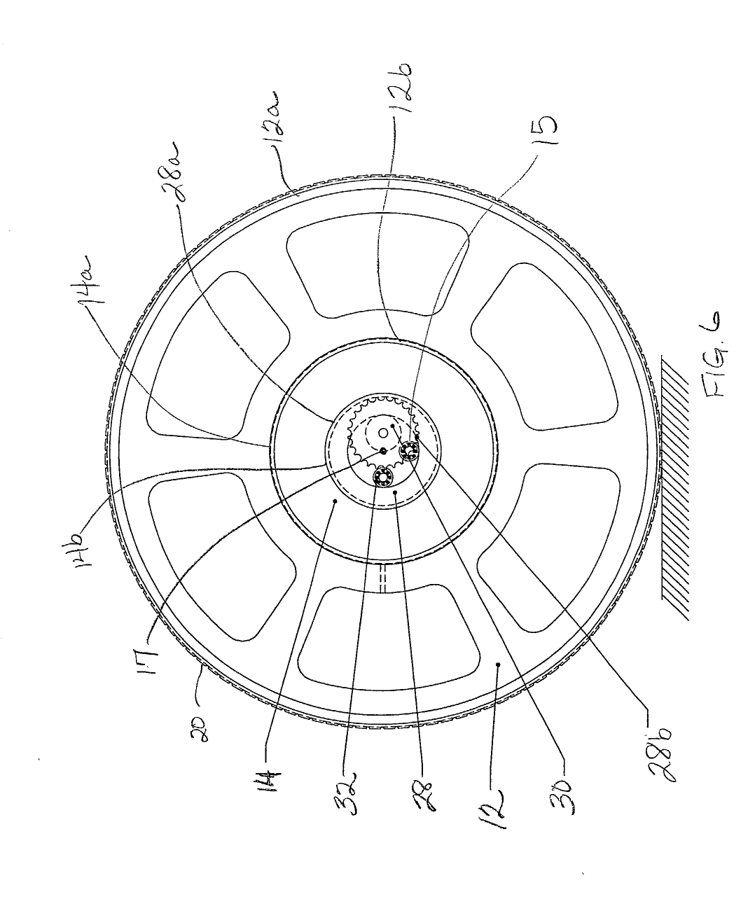

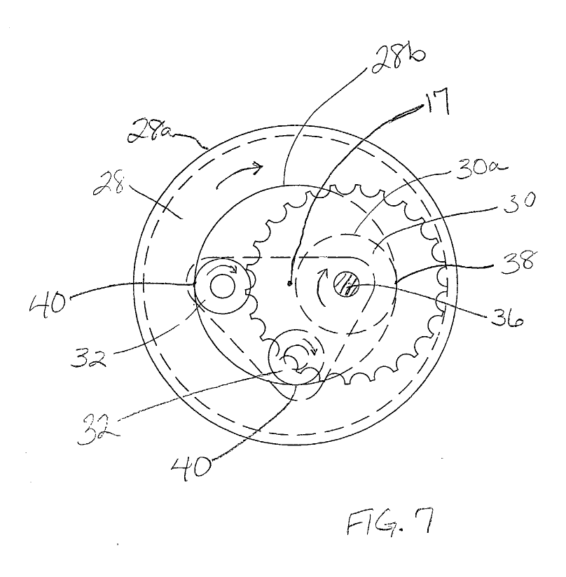

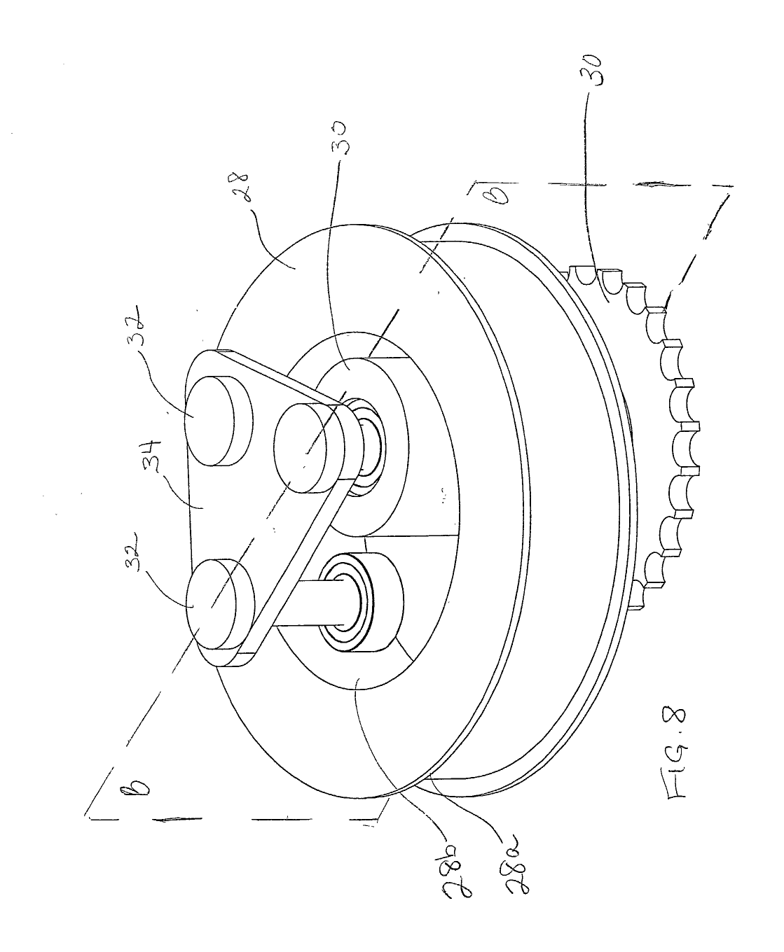

In the embodiment shown in FIGS. 6-9, roller 28 is positioned within inflatable tube 14. A hub 30 has an outer surface 30a and an inner surface 30b, and is fixedly connected to a mass by shaft 36. Hub 30 is caused to rotate by a driving mechanism, such as a motor. Hub 30 is located within roller 28 such that there is a frictional contact 38 between outer surface 30a of hub 30 and inner surface 28b of circular frame 28. Regulator 32 has an outer surface 32a, and is disposed a fixed distance away from hub 30. One or more regulators 32 are located within roller 28 such that there is a frictional contact 40 between an outer surface 32a of regulator 32 and inner surface 28b of circular frame 28, wherein the regulator 32 rolls on the inner surface 28b of roller 28. Although one method of frictional traction between roller 28, hub 30 and regulator 32 has been described above, various other methods may be also be used. In addition, various configurations of wheel apparatus 10 may be used. For example, various other shock absorbing means may be used instead of, or in addition to, inflatable tube 14, e.g., flexible bands 26 may be used between circular frame 12 and roller 28. Although wheel apparatus 10 is presently shown with two regulators 32, it will be apparent to those skilled in the art that one or more regulators may be used.

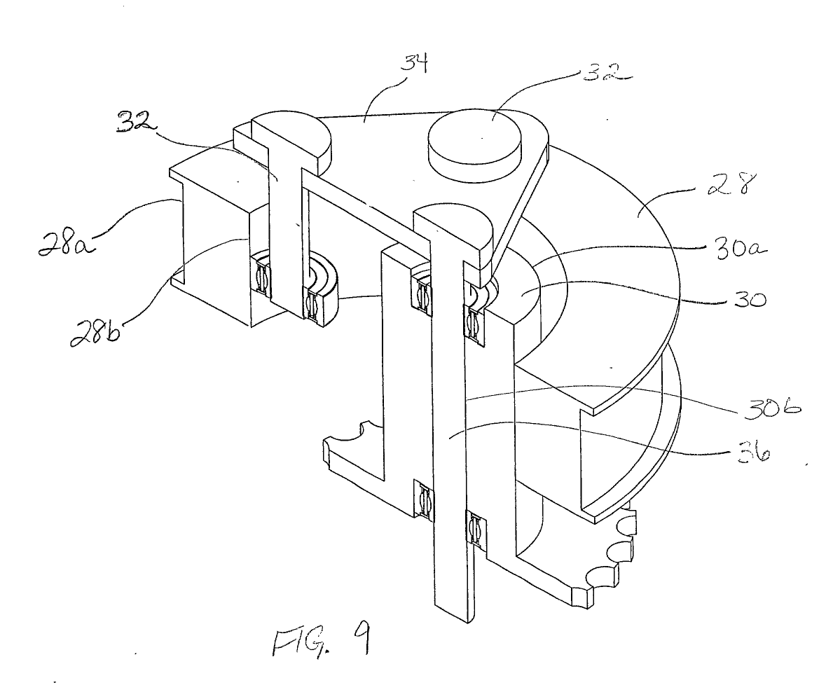

FIG. 10 is a schematic side view of a bicycle showing an embodiment of wheel apparatus 10. Both front and rear tires have been replaced with the wheel design of the present invention. One of the two wheels eliminates the bearing around the shaft, and thus inflatable tube 14 is directly connected to shaft 16.

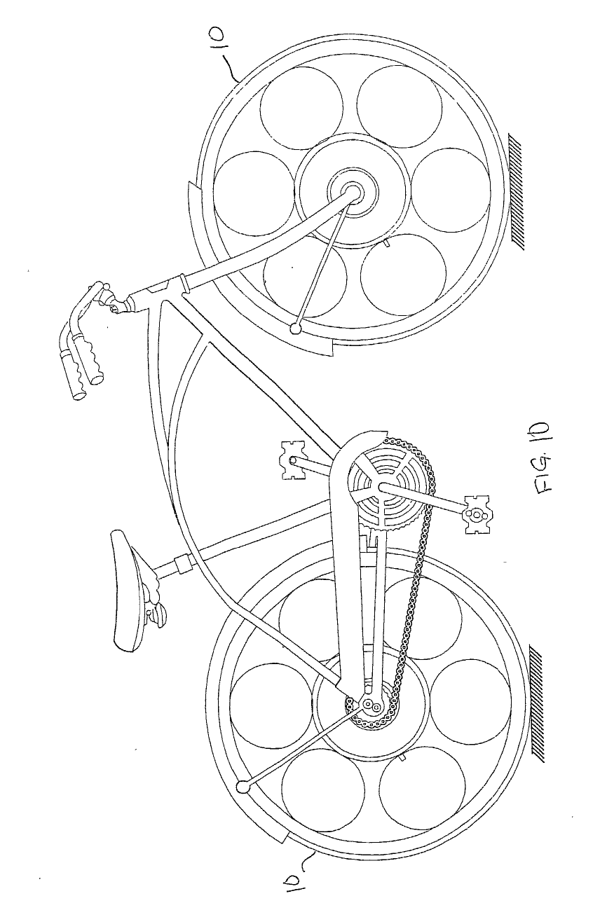

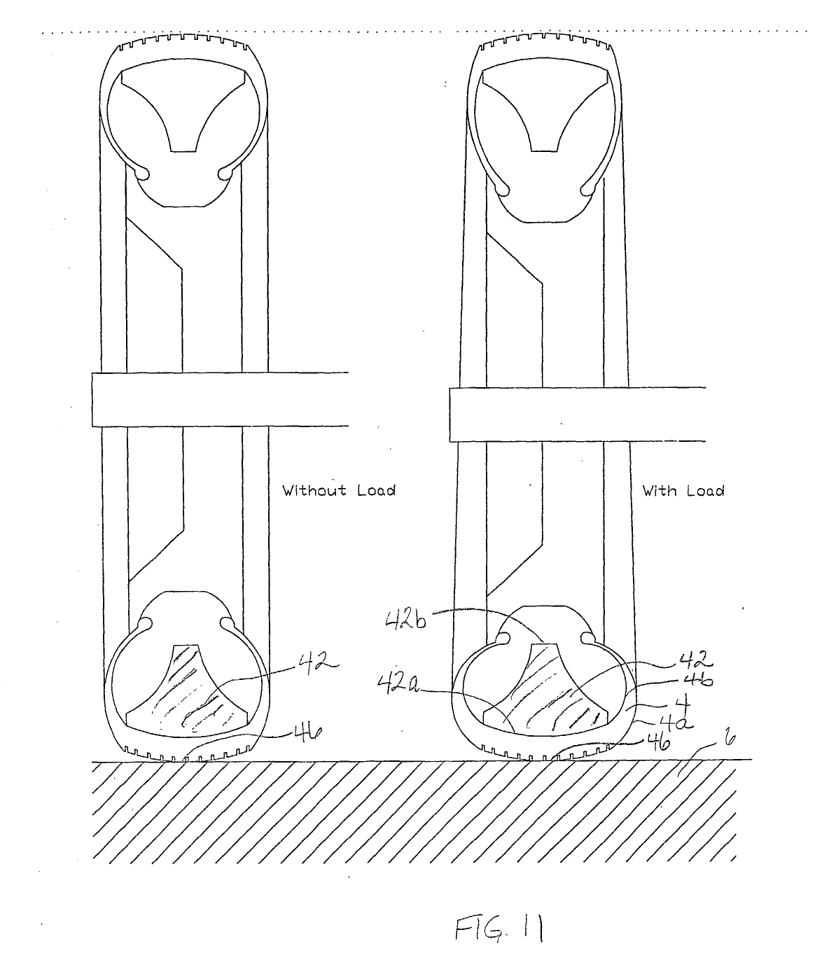

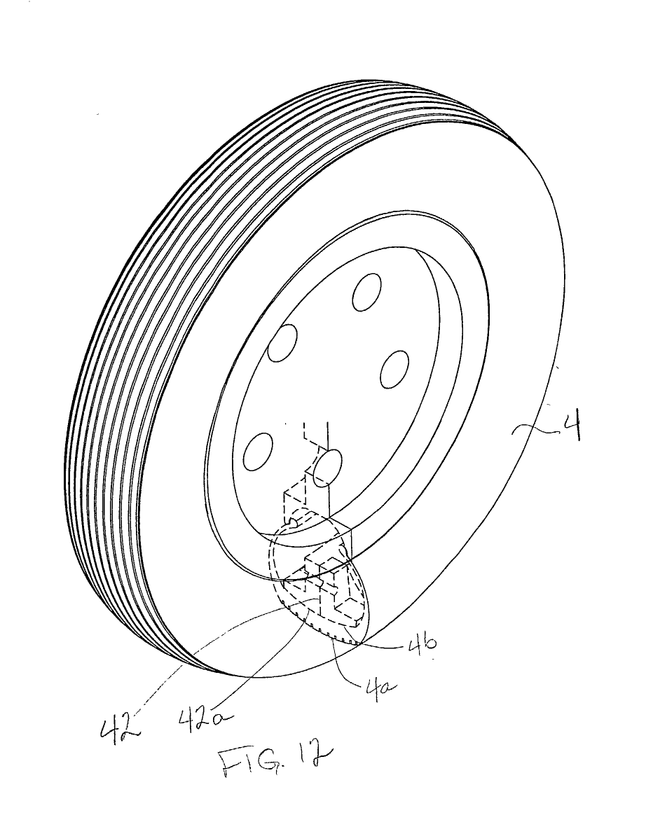

FIGS. 11-13 show a modified automobile tire with a frame 42 inserted therein. Frame 42 has an outer surface 42a and an inner surface 42b. When frame 42 is inserted into tire 4, the outer surface 42a of frame 42 is in contact with the inner surface 4b of tire 4 causing the outer surface 4a of tire 4 to become rounded. Thus, a smooth, continuous, round rolling fulcrum is created at point 46.

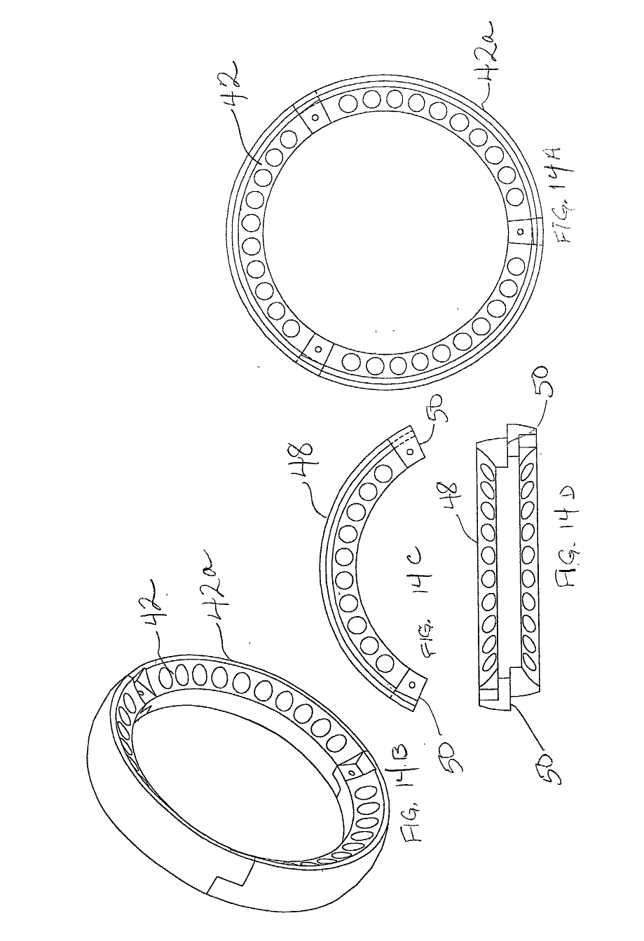

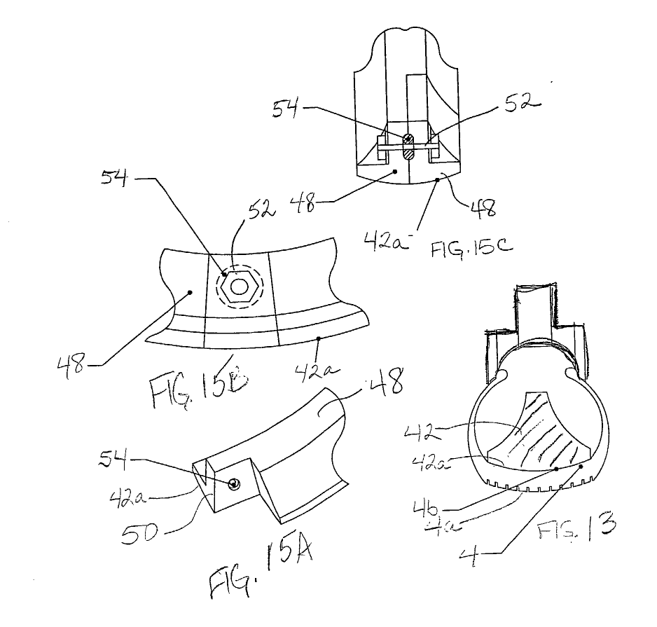

FIGS. 14A-14D are schematic views of frame 42. Frame 42 may be constructed of a single component or unitary structure, or may be constructed from a plurality of sections capable of mating with each other. When constructed of a plurality of sections, each section 48 is connected to one another near an end 50 of a section 48 by an attachment mechanism 52. Any attachment mechanism may be used such as a bolt, a snap, a screw, a notched fit, or a press fit. In addition, an O-ring 54 may be used near attachment mechanism 52 to allow section 48 of frame 42 to pivot slightly when wheel apparatus 10 moves around corners. This allows the bottom of wheel apparatus to stay parallel to the ground.

The present invention may also be adapted to a variety of wheels, such as motor vehicle and aircraft tires, castors, bicycle wheels, wheelchairs, and hand trucks. In addition, the size of the wheel frame and the shock absorption section may vary depending on the needs required in its application and are not to be limited by the illustrations provided herein.

While the invention has been described, disclosed, illustrated and shown in certain terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the description and drawings. Accordingly, other embodiments are within the scope of the following claims.

What is claimed is:

1. A wheel assembly for rolling along a rolling surface, comprising:
a circular frame capable of rolling along the rolling surface;
a rolling assembly for causing the circular frame to rotate; and
shock absorbing means connecting the rolling assembly and the circular frame;
wherein the circular frame maintains a substantially rounded area of contact with the rolling surface.

2. The wheel assembly according to claim 1 further comprising
a rolling layer disposed around the circular frame.

3. The wheel assembly according to claim 2 wherein the rolling layer comprises rubber.

4. The wheel assembly according to claim 1 wherein the shock absorbing means comprises a plurality of flexible bands.

5. The wheel assembly according to claim 4 wherein the plurality of flexible bands comprise spring steel.

6. The wheel assembly according to claim 1 wherein the shock absorbing means comprises an inflatable tube.

7. The wheel assembly according to claim 1 wherein the rolling assembly is a roller.

8. The wheel assembly according to claim 7 wherein the roller has an inner surface and further comprising
a hub capable of rotating by a driving mechanism disposed within the roller and in frictional contact with the inner surface of the roller; and
a rotatable regulator disposed within the roller at a fixed distance from the hub and in frictional contact with the inner surface of the roller.

9. The wheel assembly according to claim 1 wherein the rolling assembly is a rotatable shaft.

10. The wheel assembly according to claim 9 further comprising
a bearing disposed around the shaft.

11. The wheel assembly according to claim 10 wherein the shock absorbing means comprises an inflatable tube disposed between the bearing and the circular frame.

12. A wheel assembly for rolling along a rolling surface, comprising:
a circular frame capable of rolling along the rolling surface;
a rolling assembly including a rotatable shaft for causing the circular frame to rotate; and
a plurality of flexible bands connecting the circular frame and the rolling assembly;
wherein the circular frame maintains a substantially rounded area of contact with the rolling surface.

13. A wheel assembly for rolling along a rolling surface, comprising:
a circular frame capable of rolling along the rolling surface;
a roller having an inner surface for causing the circular frame to rotate;
a hub capable of rotating by a driving mechanism disposed within the roller and in frictional contact with the inner surface of the roller; and
a rotatable regulator disposed within the roller at a fixed distance from the hub and in frictional contact with the inner surface of the roller; and
an inflatable tube disposed between the circular frame and the roller;
wherein the circular frame maintains a substantially rounded area of contact with the rolling surface.

14. A wheel assembly for rolling along a rolling surface, comprising:
a tire having an inner surface and an outer surface, the outer surface of the tire being capable of rolling along the rolling surface; and
a frame inserted in the tire and disposed in contact with the inner surface of the tire;
wherein the tire maintains a substantially rounded area of contact with the rolling surface.

15. The wheel assembly according to claim 14 wherein the frame is a unitary structure.

16. The wheel assembly according to claim 14 wherein the frame is constructed from a plurality of sections capable of mating with each other.

17. A method of improving the rolling efficiency of a wheel assembly along a rolling surface, comprising:
providing a circular frame capable of rolling along the rolling surface; and
maintaining a substantially rounded area of contact of the circular frame with the rolling surface.

18. The method according to claim 17 wherein the maintaining step comprises absorbing forces applied to the wheel assembly within the circular frame at a location discrete from the area of contact of the circular frame with the rolling surface.

19. The method according to claim 17 further comprising
disposing a tire over the circular frame; and
wherein the maintaining step comprises inserting a frame within the tire.

20. The method according to claim 19 wherein the inserting step comprises constructing the frame within the tire.
